(19) United States
(12) Patent Application Publication
(10) Pub. No.: US 2004/0012215 A1
(43) Pub. Date: Jan. 22, 2004

(54) Deep cavity probing tool

(76) Inventor: Ming Lang Chang, Tai Chung City (TW)

Correspondence Address: CHANG, MING LANG, P.O. Box 63-150, Tai Chung City, 406, TW

(21) Appl. No.: 10/200,270

(22) Filed: Jul. 19, 2002

(51) Int. Cl. B25J 15/06

(52) U.S. Cl. 294/65.5

(57) ABSTRACT

A deep cavity probing tool comprised of a rod that provides for manual grasping and a powerful magnet attached to an extremity of the rod. The exterior periphery of the powerful magnet is ensconced in a mount constructed of a nonferrous material such that its magnetic force is focused linearly at the powerful magnet. A sleeve of steel construction is movably fitted lengthwise over the outer diameter of the mount and the length of the sleeve exceeds that of the mount, thereby concealing the end at an appropriate depth within the internal section of the sleeve. An attraction ring shoulder is disposed along the inner circumference at the lengthwise rear end of the sleeve to form a constrictive aperture of a smaller diameter to provide for the longitudinal attraction of the powerful magnet in the mount. As such, due to the effect of the sleeve shielding the magnetic force at the outer diameter and periphery of the powerful magnet, the present invention is efficiently admitted into openings to probe for objects within the spaces of interior sections to thereby effectively achieve and facilitate remote depth object searching and removal operations.

### BACKGROUND OF THE INVENTION

1) Field of the Invention

The invention herein relates to magnetic pick-up tools, specifically a deep cavity probing tool.

2) Description of the Prior Art

As is well known, a conventional automobile engine block contains various complex and, furthermore, densely situated mechanical components. During automotive maintenance, small parts are often dropped into the engine block when components are installed or removed. As engine blocks pose high temperature hazards in a confined space that do not encourage close physical proximity and, furthermore, engine block components are cramped together in a complicated arrangement that precludes manual access, a pick-up tool having a lengthy rod with a magnet at the end of the said rod is utilized to retrieve dropped parts. However, since most of the components in engine blocks are fabricated of ferrous metals, before a conventional pick-up tool magnet is admitted to probe the proximity of an opening, the powerful magnet at the tip of the pick-up tool is attracted to the said metal components such that the said pick-up tool cannot be inserted without interruption to the bottom portion of the engine block. When a targeted object magnetically attracted to the tip of the pick-up tool is drawn back out, since the pick-up tool magnet is once again attracted to metal components in the vicinity, the targeted object is impacted and falls off, which results in numerous hindrances, especially when parts drop into deeper and, furthermore, extremely narrow spaces. In view of the said situation, the inventor of the invention herein conducted extensive research to innovate the invention herein which solves the said problems.

### SUMMARY OF THE INVENTION

The primary objective of the invention herein is to provide a deep cavity probing tool that prevents the interfering attraction at the lateral extent of its powerful magnet to achieve efficient remote depth searching operation.

Therefore, the deep cavity probing tool of the invention herein is comprised of a rod that provides for manual grasping and a powerful magnet attached to an extremity of the said rod that enables entry into openings for magnetic retrieval operations, the innovative features of which includes: A deep cavity probing tool comprised of a rod that provides for manual grasping and a powerful magnet attached to an extremity of the said rod. The exterior periphery of the said powerful magnet is ensconced in a mount constructed of a non-ferrous material such that its magnetic force is focused linearly at the said powerful magnet. A sleeve of steel construction is movably fitted lengthwise over the outer diameter of the said mount and the length of the said sleeve exceeds that of the said mount, thereby concealing the end at an appropriate depth within the internal section of the sleeve. An attraction ring shoulder is disposed along the inner circumference at the lengthwise rear end of the said sleeve to form a constrictive aperture of a smaller diameter to provide for the linear attraction of the powerful magnet in the said mount. As such, due to the effect of the said sleeve shielding the magnetic force at the outer diameter and periphery of the powerful magnet, the present invention is efficiently admitted into openings to probe for objects within the spaces of interior sections and, furthermore, the said sleeve moves reciprocally on the powerful magnet that linearly attracts objects with an ultra strong magnetic force to effectively achieve and facilitate remote depth object searching and removal operations.

The enable the examination committee a further understanding of the objectives, features, and functions of the present invention, the brief description of the drawings below are followed by the detailed description of the invention herein.

### BRIEF DESCRIPTION OF THE INVENTION

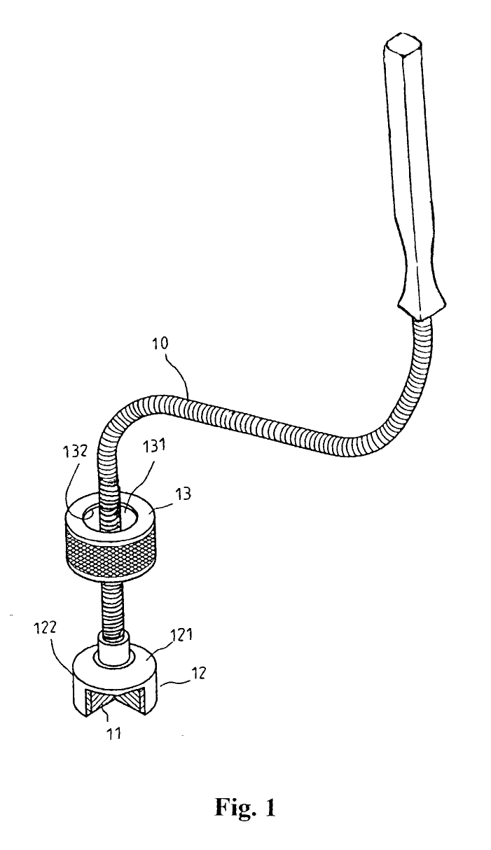

FIG. 1 is an exploded drawing of the invention herein.

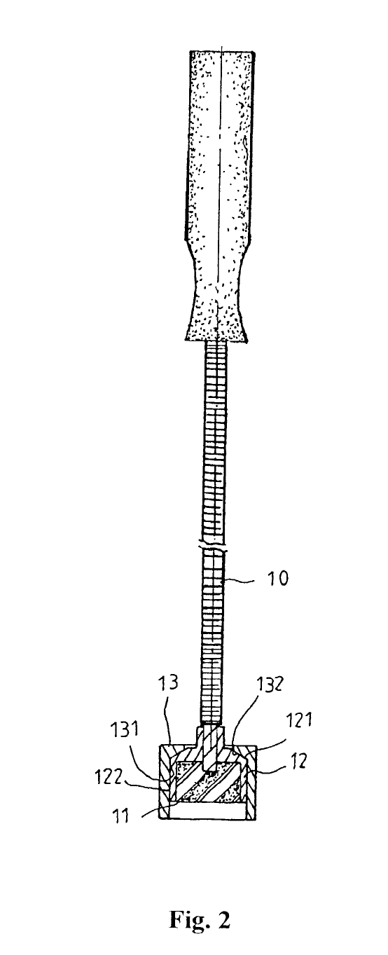

FIG. 2 is a cross-sectional drawing of the invention herein.

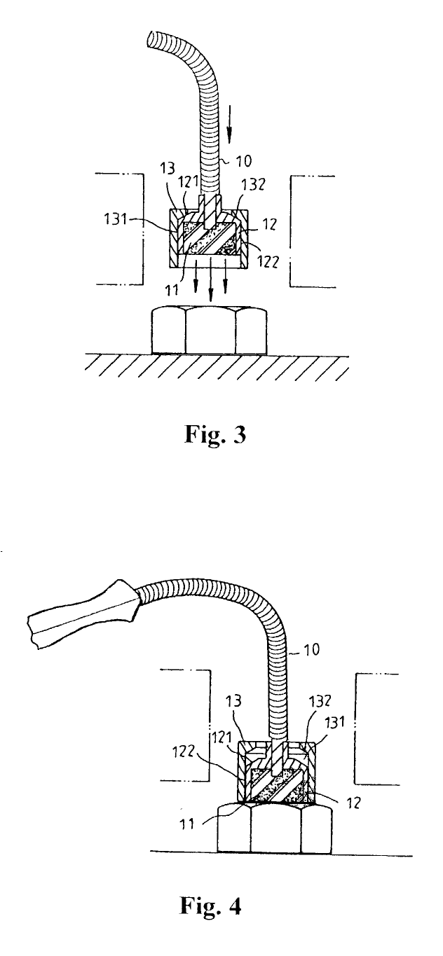

FIG. 3 is a cross-sectional drawing of the invention herein passed through an opening.

FIG. 4 is a cross-sectional drawing of the invention herein attracting an object after entrance into an opening.

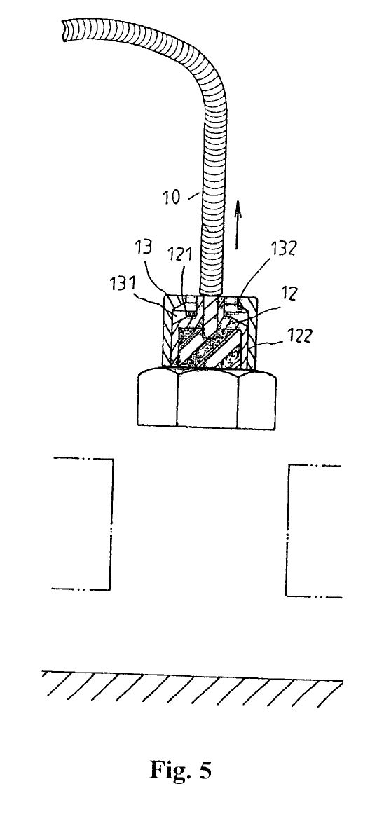

FIG. 5 is a cross-sectional drawing of the invention herein that illustrates the removal of the attracted object through the opening.

### DETAILED DESCRIPTION OF THE INVENTION

Referring to FIG. 1 and FIG. 2, the deep cavity probing tool of the invention herein is comprised of a multi-section rod 10 that provides for manual grasping and, furthermore, is extendible and retractable; a powerful magnet 11 of cylindrical shape attached to an extremity of the said rod 10; an annular mount 12 of aluminum construction secured around the exterior periphery of the said powerful magnet 11 to thereby conjoin it and the powerful magnet 11 into a single structural entity such that the magnetic force of the said powerful magnet 11 is focused in a forward linear direction; a back stop 121 of conic shape is reductively formed at the lengthwise rear end of the mount 12; and a sleeve 13 of steel construction that fits lengthwise over the outer diameter of the said annular mount 12 and is capable of moving forward and backward along the rod 10 and, furthermore, its interior opening 131 accommodates the outer wall 122 of the said mount 12 and the length of the said sleeve 13 exceeds that of the said mount 12, enabling the rear end of the said mount 12 to be concealed within the space within the internal section of the sleeve 13; additionally, an attraction ring shoulder 132 is disposed along the inner circumference at the lengthwise rear end of the said sleeve 13 to form a constrictive aperture of a smaller diameter to provide for the linear attraction of the powerful magnet 11 in the said mount 12.

When the said structure is utilized, referring to FIG. 3, FIG. 4, and FIG. 5, the magnetic force of the powerful magnet 11 fluxes through the aluminum mount 12 in which it is internally contained, thereby subjecting the sleeve 13 to the magnetic field of the said powerful magnet 11 and attracting it to the outer wall 122 of the mount 12 such that it is ordinarily compelled into position on the mount 12 outer wall 122 and, furthermore, the attraction ring shoulder 132 at the rear extent of the sleeve 13 interior opening 131 is situated against the back stop 121 constituting the posterior of the mount 12; and since the length of the said sleeve 13 exceeds that of the said mount 12, the mount 12 is concealed at an appropriate depth within its interior opening 131.

When the invention herein is extended into an engine block to remove a targeted object, the sleeve 13 at the anterior tip of the said rod 10 passes through openings leading to metal components within an engine block, at which time since the magnetic force of the powerful magnet 11 is surrounded and isolated by the sleeve 13 and, furthermore, its front end is nested at a certain depth within the internal section of the sleeve 13 such that the magnetic field of the said powerful magnet 11 is focused in a forward linear direction, the sleeve 13 is not attracted to metal components touched as the grasped rod 10 is projected into the bottom portion of the engine block.

As soon as the targeted object is contacted within the forward oriented magnetic force range of the powerful magnet 11, it is immediately attracted, and the targeted object is held against the bottom surface of the powerful magnet 11, while the sleeve 13 ascends such that the bottom surface of the sleeve 13 and the bottom surface of the powerful magnet 11 are within the same plane, as indicated in FIG. 5; furthermore, since the said sleeve 13 surrounding the outer wall 122 of the mount 12 shields the magnetic force of the said power magnet 11, when the rod 10 is withdrawn from the engine block, the powerful magnet 11 at the anterior tip of the rod 10 is not drawn to any metal components.

As such, the invention herein is not affected by ferrous metal component interference to efficiently probe for targeted objects in engine block recesses, and thereafter prevents the impact and consequent dislodging of targeted objects being retrieved; since the force of magnetic attraction along outer periphery of the said powerful magnet 11 is isolated when it is covered by the said sleeve 13 and, furthermore, surrounding the mount 12 focuses the magnetic force of the said powerful magnet 11 linearly towards the forward end, the force of attraction at the front end for the positive acquisition of targeted objects is thereby strengthened such that retrieved objects are not easily susceptible to impact and subsequent dislodging; although simple in concept, since the invention herein is practical, capable of considerable progressive utility and, furthermore, completely eliminates the operational shortcomings of the prior art, the invention herein is lawfully submitted to the patent bureau as a patent application.

1. A deep cavity probing tool comprised of a rod that provides for manual grasping and a powerful magnet attached to an extremity of the said rod that enables entry into openings for magnetic retrieval operations, the innovative features of which includes:
The exterior periphery of the said powerful magnet is ensconced in a mount constructed of a non-ferrous material and a sleeve of steel construction is movably fitted lengthwise over the outer diameter of the said mount such that the end is concealed at an appropriate depth within the internal section of the said sleeve, wherein a back stop of conic shape is reductively formed at the lengthwise rear end of the said mount, enabling the magnetic force of the said powerful magnet to be focused in a linear orientation; an attraction ring shoulder is disposed along the inner circumference at the lengthwise rear end of the said sleeve to form a constrictive aperture of a smaller diameter such that when the magnetic force of the said powerful magnet in the said mount is attracting linearly, the back stop and the attraction ring shoulder are restricted against each other; as such, due to the effect of the said sleeve shielding the magnetic force at the outer diameter and periphery of the said powerful magnet, the present invention is efficiently admitted into openings to probe for objects within the spaces of interior sections and, furthermore, the said sleeve moves reciprocally on the said powerful magnet that linearly attracts objects with an ultra strong magnetic force to effectively achieve and facilitate remote depth object searching and removal operations.

2. As mentioned in claim 1 of the deep cavity probing tool of the invention herein, the said mount is of aluminum construction.
